(19) United States
(12) Patent Application Publication
(10) Pub. No.: US 2020/0046171 A1
(43) Pub. Date: Feb. 13, 2020

(54) PORTABLE BLENDING APPARATUS WITH INTEGRATED SPEAKER

(71) Applicant: ESI Cases & Accessories, New York, NY (US)

(72) Inventor: Michelle Sirju, New York, NY (US)

(21) Appl. No.: 16/438,914

(22) Filed: Jun. 12, 2019

Related U.S. Application Data
(63) Continuation-in-part of application No. 29/659,664, filed on Aug. 10, 2018.

(51) Int. Cl. A47J 43/07; A47J 19/00; H04R 1/02

(52) U.S. Cl. CPC A47J 43/0722; H04R 2420/07; H04R 1/028; A47J 19/00

(57) ABSTRACT

The combination of a blending apparatus and a wireless speaker, comprising: a base having one or more battery devices and a blending blade. An electric motor is connected to the blending blade and coupled to the one or more battery devices. An electrical processing device is coupled to the one or more battery devices and controls the electric motor through a power switching device. A radio transceiver is separately coupled to the one or more battery devices and one or more speaker devices are connected to the radio transceiver. The speaker devices output an audio signal from the radio transceiver. There is a fluid compartment detachably engaged with the base and a lid detachably engaged with the fluid compartment.

### CROSS-REFERENCE TO RELATED APPLICATION

The present application is a continuation-in-part of U.S. patent application Ser. No. 29/659,664, filed Aug. 10, 2018, the entire contents of each of which are incorporated by reference herein.

### FIELD OF THE INVENTION

The present invention relates to a portable blending apparatus with an integrated wireless speaker for pairing with, and projecting music from, a mobile apparatus.

### BACKGROUND OF THE INVENTION

Blenders and other food processors have long been developed for use in kitchens for producing various foods and drinks. With continued developments in health consciousness, juices, smoothies, and other drinks based on fruits and vegetables have become a popular replacement for bottled and packaged drinks, especially for workout replenishment. One popular product as a result of these developments is the portable blender for use after workouts. Fruits and vegetables, along with any supplements, can be mixed at a user's convenience after such workouts, or for any outdoor use, such as hiking, camping, and the like. For further convenience, such portable blenders are usually powered by rechargeable batteries so that their use is not limited by the availability of other power sources, at least temporarily.

### SUMMARY OF THE INVENTION

With the ubiquitous use of such portable blenders in more and more varied environments, it has been recognized that an integration of other functions to the blenders would offer users with additional convenience—for example, by reducing the number of portable devices needed.

In view of the above, there is a need for a portable blender with an integrated wireless speaker that can provide audio entertainment in concurrence with preparing various drinks using the blender.

According to an exemplary embodiment of the invention, a blending apparatus, comprises: a base comprising: one or more battery devices; a blending blade; an electric motor connected to the blending blade and coupled to the one or more battery devices; a processing device coupled to the one or more battery devices that controls the electric motor through a power switching device; a radio transceiver separately coupled to the one or more battery devices; and one or more speaker devices connected to the radio transceiver and that outputs an audio signal from the radio transceiver; a fluid compartment detachably engaged with the base; and a lid detachably engaged with the fluid compartment.

According to an exemplary embodiment of the invention, the one or more battery devices provide power to one or both of the radio transceiver and the electric motor.

According to an exemplary embodiment of the invention, the electric motor is connected to a microcontroller that controls the operation of the electric motor.

According to an exemplary embodiment of the invention, the microcontroller detects a power level of the one or more battery devices.

According to an exemplary embodiment of the invention, the microcontroller controls the operation of the electric motor based at least in part on the detected power level.

Other features and advantages of the present invention will become readily apparent from the following detailed description and the accompanying drawings.

### BRIEF DESCRIPTION OF THE DRAWINGS

FIGS. 1A, 1B, and 1C are front, back, and bottom views, respectively, of a portable blending apparatus with an integrated speaker in accordance with an exemplary embodiment of the invention.

FIG. 2A is an exploded view of the blending apparatus of FIGS. 1A, 1B, and 1C with its base, fluid compartment, and lid detached from one another.

FIG. 2B is a diagram showing a base of the blending apparatus according to an exemplary embodiment of the invention.

FIG. 2C is a diagram showing a fluid compartment of the blending apparatus according to an exemplary embodiment of the invention.

FIG. 3 is a schematic diagram illustrating the internal circuitry of the portable blending apparatus of FIGS. 1A-C according to an exemplary embodiment of the invention.

The above and related objects, features and advantages of the present invention will be more fully understood by reference to the following, detailed description of the preferred, albeit illustrative, embodiment of the present invention when taken in conjunction with the accompanying figures, wherein:

### DETAILED DESCRIPTION

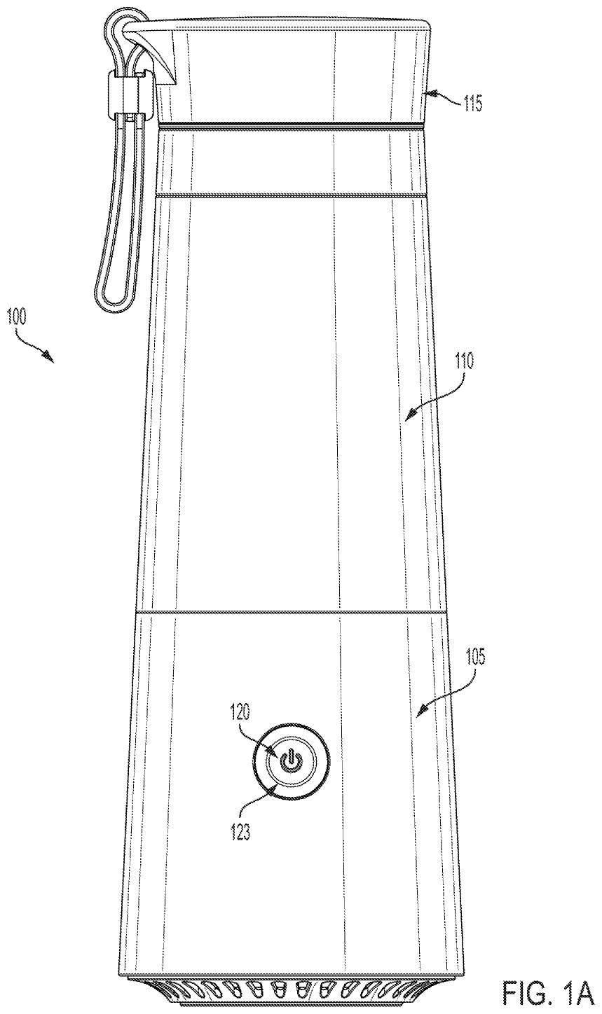

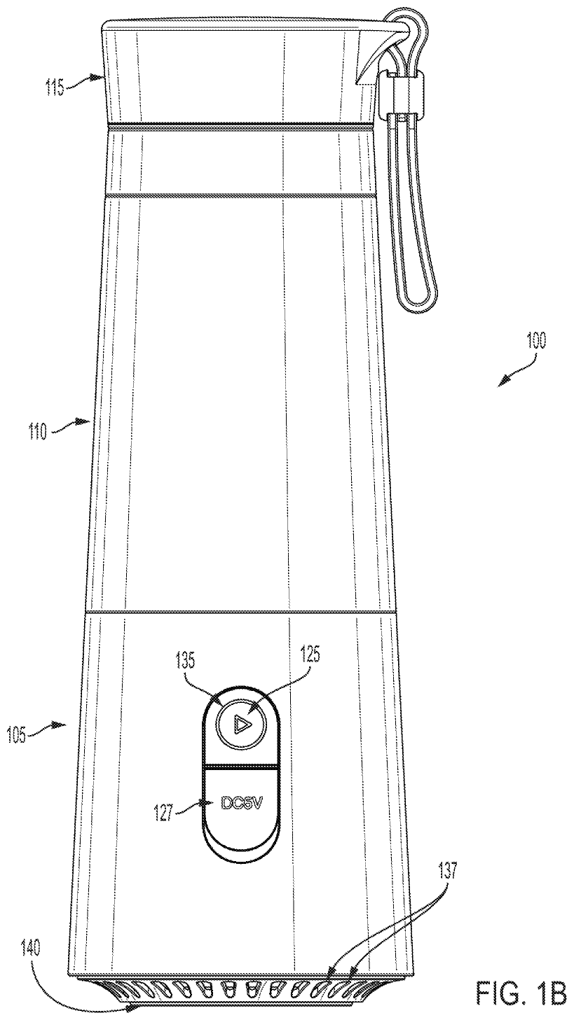

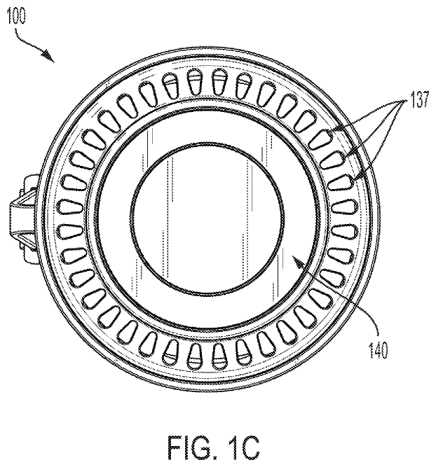

FIGS. 1A, 1B, and 1C are front, back, and bottom views, respectively, of a portable blending apparatus with an integrated speaker in accordance with an exemplary embodiment of the invention. As shown in FIG. 1A, blending apparatus 100 comprises a base 105, a fluid compartment 110, and a lid 115. As will be described in further detail below with reference to FIG. 1D, the base 105, fluid compartment 110, and lid 115 may be detached from one another in various configurations and uses of the blending apparatus 100. Referring back to FIG. 1A, blending apparatus 100 comprises, in base 105 thereof, a blender power button 120 that internally couples a power source to a blending motor, as will be described in further detail below. A user may toggle the blending apparatus on and off by pressing on blender power button 120, which may be embodied by a momentary push button switch and the like. In accordance with an exemplary embodiment of the invention, blender power button 120 is surrounded by a light indicator ring 123, which may be illuminated internally by one or more light emitting diodes (LEDs), and the like, for indicating various operating states of blending apparatus 100. For example, indicator ring 123 may flash red when blender power button 120 is depressed—or when blending apparatus 100 is in operation—while the internal rechargeable battery is low on power, thereby indicating to the user that blending apparatus 100 needs recharging, or connection to a power source, for further use. Correspondingly, indicator ring 123 may flash blue when blending apparatus 100 is coupled to an external power source, thereby indicating that the internal battery is being charged. Alternatively, indicator ring 123 may show respective colors while blending apparatus 100 is coupled to the external power source to indicate respective charge levels of the internal battery.

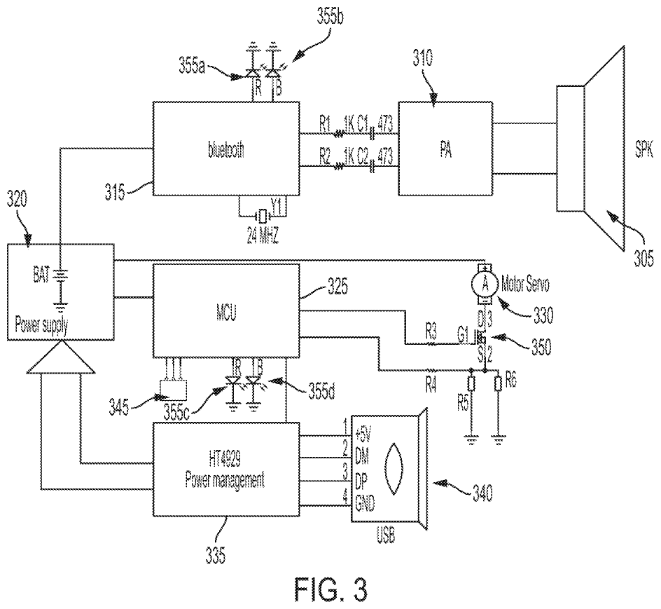

Referring now to FIG. 1B, base 105 further comprises a speaker power button 125 and a flexible cover 127 that may be opened to access a power port (not shown) (external port 340 shown in FIG. 3). According to an exemplary embodiment of the invention, power port (not shown) may conform to the microUSB standard, or the like, for receiving a power cord (not shown). Flexible cover 127 allows for a power cord to be connected to an external port (external port 340 described in further detail below) for recharging the internal battery of blending apparatus 100 while providing protection so that fluids contained in compartment 110 would not spill into the external port during blending and/or normal use of the blending apparatus 100. Similar to blender power button 120, speaker power button 125 may be embodied by a momentary push button switch for toggling the speaker of blending apparatus 100 on and off. Additionally, speaker power button 125 may also be surrounded by a light indicator ring 135, which may be illuminated internally by one or more light emitting diodes (LEDs), and the like, for indicating various operating states of the speaker in the blending apparatus 100—for example, for indicating power on, pairing status under the Bluetooth® standard, battery power status, to name a few.

Next, as shown in FIGS. 1B and 1C, the bottom portion of base 105 of blending apparatus 100 comprises a number of openings 137 for allowing sound to travel from an internal speaker (not shown) outward and to, thereby, function as a wireless speaker to a mobile device, as will be described in further detail below. According to an exemplary embodiment of the invention, the internal speaker substantially overlaps the center portion 140 of the bottom of base 105 so that openings 137 do not directly expose the internal speaker and to, thereby, minimize any liquids contained in fluid compartment 110 from entering the internal speaker.

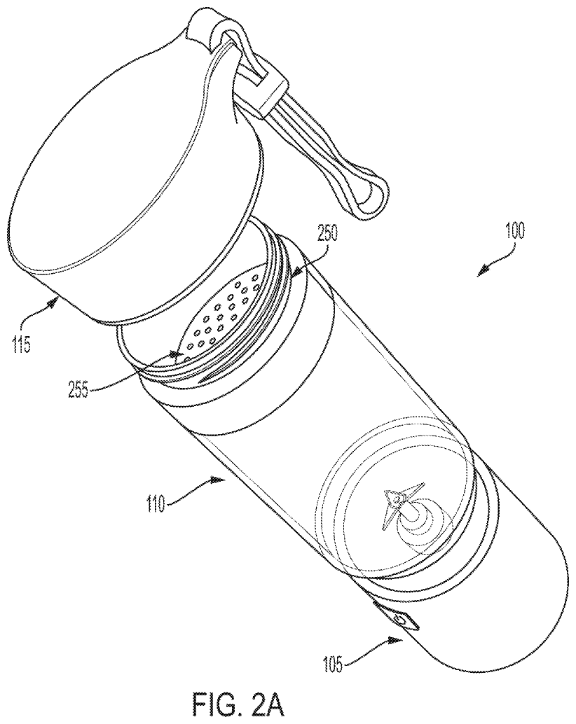

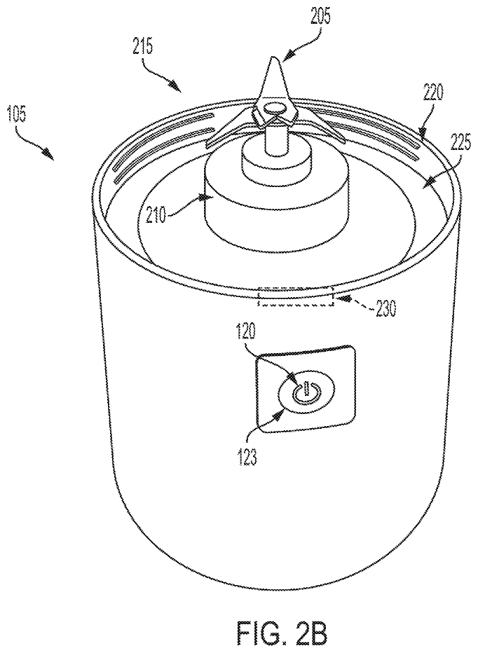

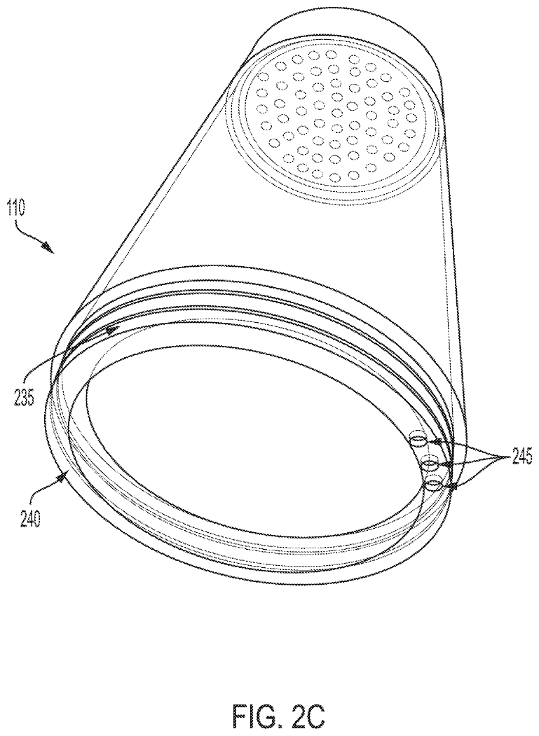

FIG. 2A is an exploded view of blending apparatus 100 with base 105, fluid compartment 110, and lid 115 detached from one another. As illustrated in FIG. 2A, these parts are attachable to one another by threaded engagement to form a watertight compartment of blending apparatus 100. In embodiments, other types of detachable assemblies may be used, such as snap-fit assemblies, bayonet fit, and the like.

Referring now to FIG. 2B, base 105 of blending apparatus 100 serves as a housing for the internal powered components—including, as will be described in further detail below, a motor for driving a blending blade 205 positioned at the center, on a pedestal 210, of the circular top surface 215 of base 105. The circular top surface 215 of base 105 serves as the watertight bottom portion of fluid compartment 110 of blending apparatus 100 when it is assembled, as shown in FIGS. 1A-1C.

Referring back to FIG. 2B, blending blade 205 includes four blade elements at predetermined angles from one another that, when rotated at high speeds by the internal motor, cause liquid in fluid compartment 110 of blending apparatus 100 to mix and swirl, while substantially breaking down any solid material therein. In embodiments, blending blade 205 may comprise any number of blade elements in various angled and layered configurations.

As further shown in FIG. 2B, a threaded portion 220 extends upward around the circumference of the top surface 215, with threads facing inward to thereby provide for threaded engagement with fluid compartment 110. According to an exemplary embodiment of the invention, base 105 comprises a resilient material ring or gasket 225 around the circumference at the bottom of threaded portion 220. Gasket 225 may be made of a soft polymer that deforms to the contours of the bottom of fluid compartment 110 when blending apparatus 100 is assembled in order to form a watertight seal around the joint between fluid compartment 110 and base 105. In accordance with an exemplary embodiment, a magnetic sensor—such as a magnetic induction switch and the like—is positioned under the gasket 225 at a position 230 proximate the blender power button 120. Correspondingly, as will be described in further detail below, fluid compartment 110 incorporates one or more metallic members that align with the magnetic sensor located at position 230 when blending apparatus is properly assembled. Thus, blender power button 120 is activated only when the one or more metallic members are aligned with position 230 so that blending blade 205 cannot be activated when blending apparatus 100 is not properly assembled. As such, there is no risk of blending blade 205 activating when base 105 is disassembled and blending blade 205 is exposed. And the magnetic sensor also provides for ensuring a proper assembly of blending apparatus 100 so that a watertight seal is formed whenever blending blade 205 is activated, reducing the risk of leaks and spills. Accordingly, the safety and efficacy of blending apparatus 100 is improved.

Next, as shown in FIG. 2C, cylindrical fluid compartment 110 includes a threaded portion 235, having a reduced radius and outward facing threads, for engaging threaded portion 220 of base 105. As shown in FIGS. 1A-1C, the outer circumference of fluid compartment 110 substantially aligns with the outer circumference of base 105 when blending apparatus 100 is assembled. Referring back to FIG. 2C, bottom portion 240 of fluid compartment 110 forms a ring that substantially overlaps gasket 225 when blending apparatus 100 is assembled. According to an exemplary embodiment of the invention, fluid compartment 110 is made from a rigid polymeric material so that gasket 225 deforms to the contours of bottom portion 240 to form a watertight seal when blending apparatus 100 is assembled. As further shown in FIG. 2C, bottom portion 240 includes three (3) metallic members 245 that align with position 230 shown in FIG. 2A when blending apparatus 100 is assembled. As described above, blender power button 120 is activated only when metallic members 245 are aligned with position 230 and a magnetic sensor (not shown) in base 105 detects their presence at position 230. In embodiments, a main portion of fluid compartment 110 may be made of a transparent or translucent material to allow a user to observe the blended fluids.

Referring now back to FIG. 2A, a top portion 250 of fluid compartment 110 and lid 115 each have corresponding threaded portions for engaging one another to form a seal when blending apparatus 100 is in use. As further shown in FIG. 2A, top portion 250 incorporates a straining element 255 for straining large particulates when fluid is poured out or consumed. According to an exemplary embodiment of the invention, lid 115 may be attached to fluid compartment 110 when it is disengaged from base 105 in an upside-down orientation so that fluid compartment 110 may serve as a cup after blending.

FIG. 3 is a schematic circuit diagram of the internal powered components housed in base 105 according to an exemplary embodiment of the invention. As shown in FIG. 3, the main internal components of base 105 include a speaker 305, a power amplifier 310, a radio signal receiver 315, a power supply assembly 320, a microcontroller (“MCU”) 325, a motor 330, a power source management circuit 335, an external port 340, a magnetic induction switch 345, a transistor 350, and light emitting diodes (LEDs) 355a, 355b, 355c, and 355d.

According to an exemplary embodiment of the invention, speaker 305 is positioned proximate the center portion 140 of the bottom of base 105 shown in FIGS. 1B and 1C and described above. Referring back to FIG. 3, speaker 305 is driven by power amplifier 310 and both are connected to radio signal transceiver/controller 315 which, according to an exemplary embodiment of the invention, is a transceiver/controller operating in accordance with the Bluetooth® standard. The output connection from transceiver/controller 315 to power amplifier 310 may be through, for example, parallel resistor/capacitor sets, R1 and R2 (at 1K Ohms) and C1 and C2 (at 2 pF (pico Farads); EIA code 473). As shown in FIG. 3, the Bluetooth® radio transceiver/controller 315 is tuned to a 24 Mhz (megahertz) reference frequency according to an exemplary embodiment. Other frequencies may also be used. Transceiver/controller 315 is also connected to LEDs 355a and 355b that each indicate a respective operating state of the receiver/controller 315 and, by extension, speaker 305.

Corresponding to the description above in connection with FIG. 1B, LEDs 355a and 355b (red “R” and blue “B,” respectively) illuminate light indicator ring 135 that surrounds speaker power button 125 for indicating various operating states of speaker 305 in blending apparatus 100—for example, for indicating power on, pairing status under the Bluetooth® standard, battery power status, to name a few. These operating states may be indicated by one or more of LEDs 355a and 355b being illuminated, and at predetermined respective intervals. The receiver/controller 315 is coupled to power supply assembly 320 as its power source and for relaying/controlling power supply to speaker 305, power amplifier 310, and LEDs 355a and 355b. In operation, Bluetooth® radio transceiver/controller 315 may be controlled and/or toggled on and off by speaker power button 125 illustrated in FIG. 1B (not shown in FIG. 3). Advantageously, blender apparatus 100 may be paired with a mobile device, such a cellular phone and the like, via Bluetooth® radio transceiver/controller 315 so that speaker 305 may serve as a music or spoken word (e.g., audiobooks or podcasts and the like) output for the mobile device—thus, a separate speaker device is not needed.

Power supply assembly 320 is separately connect to microcontroller 325 and motor 330, respectively, as illustrated in FIG. 3. According to an exemplary embodiment, power supply assembly 320 comprises one or more rechargeable batteries that store and output sufficient power for concurrent operations of both speaker 305 and motor 330. According to an exemplary embodiment of the invention, the power supply assembly 320 provides electric power at 3.7V (volts) and has a 2000 mAh (milliamp Hour) capacity. Microcontroller 325 is also connected to power source management circuit 335, magnetic induction switch 345, transistor 350, LEDs 355c and 355d.

Blender power button 120 (not shown in FIG. 3) is connected to microcontroller 325 via magnetic induction switch 345. Thus, in operation and as described above, microcontroller 325 detects a user pressing blender power button 120 only when magnetic induction switch 345 is closed by metallic members 245 being aligned with position 230. Once microcontroller 325 detects blender power button 120 being toggled, it, in turn, switches transistor 350 to thereby power on motor 330, which drives blending blade 205 (not shown in FIG. 3). As shown in FIG. 3, microcontroller 325 is connected to the gate and source of transistor (e.g., n-channel MOSFET) 350 through respective 1 k (1,000) Ohm resistors R3 and R4. The connection at the source of transistor 350 is grounded via parallel current limiting resistors R5 and R6, each of which has a 1 Ohm resistance.

Microcontroller 325 also detects for a connection to an external power source at external port 340 via power management circuit 335 (e.g., model HT4929E IC chip available from HotChip®). According to an exemplary embodiment of the invention, external port 340 conforms to the microUSB standard and receives 5V DC (direct current) to power management circuit 335 upon connecting to an external power source—which may be an electrical outlet through an AC/DC adaptor or an external battery and the like. Upon detecting such an external connection, microcontroller 325 triggers LEDs 355c and 355d (red “R” and blue “B,” respectively) to indicate a power status of power supply assembly 320—for example, a charging level and/or a charge completion of the one or more rechargeable batteries comprised therein.

In embodiments, microcontroller 325 may detect a power level of power supply assembly 320 and prioritize either speaker 305 or motor 320 by controlling

While in the foregoing specification a detailed description of specific embodiments of the invention was set forth, it will be understood that many of the details herein given may be varied considerably by those skilled in the art without departing from the spirit and scope of the invention.

1. A blending apparatus, comprising:
a base comprising:
one or more battery devices;
a blending blade;
an electric motor connected to the blending blade and coupled to the one or more battery devices;
a processing device coupled to the one or more battery devices that controls the electric motor through a power switching device;
a radio transceiver separately coupled to the one or more battery devices; and
one or more speaker devices connected to the radio transceiver, the one or more speaker devices being adapted to output an audio signal from the radio transceiver;
a fluid compartment detachably engaged with the base; and
a lid detachably engaged with the fluid compartment.

2. The blending apparatus of claim 1, wherein the radio transceiver is adapted to transmit and receive radio signals conforming to the Bluetooth™ standard.

3. The blending apparatus of claim 1, wherein the base further comprises:
a first power button for toggling the radio transceiver and the one or more speaker devices on and off; and
a second power button for toggling the electric motor on and off.

4. The blending apparatus of claim 3, wherein the processing device is further adapted to control a power supply from the one or more battery devices to allow concurrent operation of the radio transceiver, the one or more speaker devices, and the electric motor.
